(19) United States
(12) Patent Application Publication
(10) Pub. No.: US 2026/0127579 A1
(43) Pub. Date: May 7, 2026

(54) ELECTRONIC DEVICE FOR REQUESTING CHANGE OF OWNERSHIP OF NON-FUNGIBLE TOKEN, OPERATION METHOD THEREOF, AND SERVER

(71) Applicant: SAMSUNG ELECTRONICS CO., LTD., Suwon-si (KR)

(72) Inventors: Hyungil CHO, Suwon-si (KR); Sangmin Kim, Suwon-si (KR)

(73) Assignee: SAMSUNG ELECTRONICS CO., LTD., Suwon-si (KR)

(21) Appl. No.: 19/439,022

(22) Filed: Jan. 2, 2026

Related U.S. Application Data
(63) Continuation of application No. PCT/KR2024/008881, filed on Jun. 26, 2024.

(30) Foreign Application Priority Data
Jul. 4, 2023 (KR) 10-2023-0086184
Dec. 4, 2023 (KR) 10-2023-0173792

(51) Int. Cl. G06Q 20/36; G06Q 20/38

(52) U.S. Cl. CPC G06Q 20/367; G06Q 20/389

(57) ABSTRACT

An electronic device to transfer the ownership of an NFT on a blockchain, and a method for the same are provided. The method includes obtaining first identification information associated with an external electronic device and second identification information of a non-fungible token (NFT) associated with the external electronic device; and based on obtaining the first identification information and the second identification information, transmitting, to a server, a first blockchain address of a first wallet application stored in the electronic device, first account information of a user of the electronic device, the first identification information, and the second identification information, the transmission including a request to change an ownership of the NFT created in a blockchain network, wherein based on the first blockchain address and the first account information being included in the NFT in the blockchain network, the ownership of the NFT is changed to the first blockchain address.

### CROSS-REFERENCES TO RELATED APPLICATIONS

This application claims priority to International Application No. PCT/KR2024/008881, filed on Jun. 26, 2024, which is based on and claims priority to Korean Patent Application No. 10-2023-0086184, filed on Jul. 4, 2023, and Korean Patent Application No. 10-2023-0173792, filed on Dec. 4, 2023, in the Korean Intellectual Property Office, the disclosures of which are incorporated by reference herein in their entireties.

### BACKGROUND

### 1. Field

The disclosure relates to an electronic device requesting change of ownership of a non-fungible token (NFT), a method of operating the same, and a server.

### 2. Related Art

Since blockchain-based bitcoin became public, blockchain has applications in various sectors, such as smart contract-based platform services or non-fungible token (NFT), cloud storage services, blockchain computing services, as well as electronic currency (cryptocurrency or virtual currency) systems, e.g., bitcoin.

A blockchain platform allows system participants (nodes) to distribute and store data in their respective blocks, thus substantially free from data forgery and falsification (reliability) and allowing the participants to own their distributed information (transparency), with no need for a separate central server manager.

An NFT may refer to a virtual token that proves ownership of digital assets using blockchain technology. For example, an NFT may be used to indicate unique originality and ownership by including an address pointing to digital files such as images and videos within the token. An NFT may be guaranteed its uniqueness by permanently recording transaction history on the blockchain.

### SUMMARY

According to an aspect of the disclosure, an electronic device may include a camera; a communication circuit; a processor; and memory configured to store instructions, where the instructions, when executed by the processor individually or collectively, cause the electronic device to obtain first identification information associated with an external electronic device and second identification information of a non-fungible token (NFT) associated with the external electronic device; and based on obtaining the first identification information and the second identification information, transmit, to a server through the communication circuit, a first blockchain address of a first wallet application stored in the memory, first account information of a user of the electronic device, the first identification information, and the second identification information, the transmission comprising a request to change an ownership of the NFT created in a blockchain network, where when the first blockchain address and the first account information are comprised in the NFT in the blockchain network, the ownership of the NFT is changed to the first blockchain address.

According to an aspect of the disclosure, a method of operating a first electronic device may include obtaining first identification information associated with an external electronic device and second identification information of a non-fungible token (NFT) associated with the external electronic device; and based on obtaining the first identification information and the second identification information, transmitting, to a server, a first blockchain address of a first wallet application stored in the electronic device, first account information of a user of the electronic device, the first identification information, and the second identification information, the transmission including a request to change an ownership of the NFT created in a blockchain network, wherein based on the first blockchain address and the first account information being included in the NFT in the blockchain network, the ownership of the NFT is changed to the first blockchain address.

According to an aspect of the disclosure, a server may include a database storing user information including account information and blockchain addresses of users, a communication unit, and a controller. According to an embodiment, the controller may be configured to request the blockchain network to change ownership of an NFT for the external electronic device to the first blockchain address through the communication unit, based on receiving first identification information of an external electronic device, second identification information of an NFT for the external electronic device, a first blockchain address of the electronic device, and first account information of a user of the electronic device from an electronic device. According to an embodiment, the controller may be configured to monitor changes in ownership of a non-fungible token (NFT) for an external electronic device 207 through a blockchain network. According to an embodiment, the controller may be configured to transmit information about ownership of the NFT to the external electronic device if a change in ownership of the NFT is identified.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device in a network environment 100 according to various embodiments;

FIG. 2 is a block diagram illustrating a system including an electronic device, a server, and a blockchain network, according to an embodiment;

FIG. 3A is a block diagram illustrating an electronic device according to an embodiment;

FIG. 3B is a block diagram illustrating a server according to an embodiment;

FIG. 4A is a flowchart illustrating a method for an electronic device to obtain ownership of an non-fungible token (NFT) for an external electronic device, according to an embodiment;

FIG. 4B is a flowchart illustrating a method for an electronic device to change ownership of an NFT for an external electronic device, according to an embodiment;

FIG. 5 is a flowchart illustrating a method of operating a server when a change in ownership of an NFT for an external electronic device is identified, according to an embodiment;

FIG. 6A is a flow diagram illustrating a method for an electronic device to obtain ownership of an NFT for an external electronic device purchased by a user of the electronic device, according to an embodiment;

FIG. 6B is a view illustrating a method of obtaining ownership of an NFT, according to an embodiment;

FIG. 7A is a flow diagram illustrating a method for an electronic device to transfer ownership of an NFT for an external electronic device sold by a user of the electronic device, according to an embodiment;

FIG. 7B is a view illustrating a method of transferring ownership of an NFT, according to an embodiment;

FIG. 7C is a view illustrating a method for a server to update user information according to transfer of ownership of an NFT, according to an embodiment;

FIG. 8A is a flowchart illustrating a method of issuing an NFT for an external electronic device to a blockchain network, according to an embodiment;

FIG. 8B is a flow diagram illustrating a method of issuing an NFT for an external electronic device to a blockchain network, according to an embodiment;

FIG. 9 is a flowchart illustrating a method for a server to burn an NFT for an external electronic device, according to an embodiment; and

FIG. 10 is a view illustrating a method for an electronic device to transfer ownership of an NFT for an external electronic device through a user interface, according to an embodiment.

### DETAILED DESCRIPTION

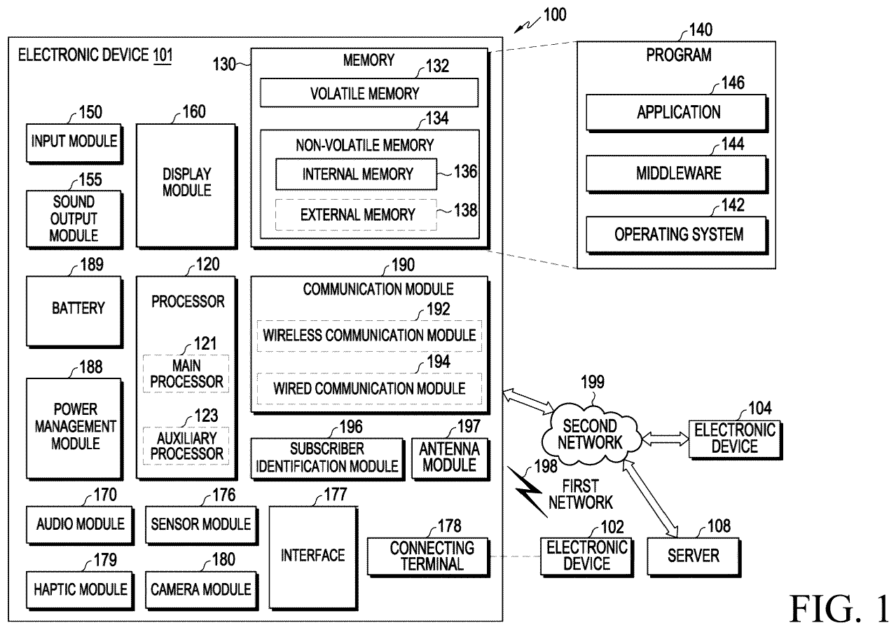

FIG. 1 is a block diagram illustrating an electronic device 101 in a network environment 100 according to various embodiments. Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

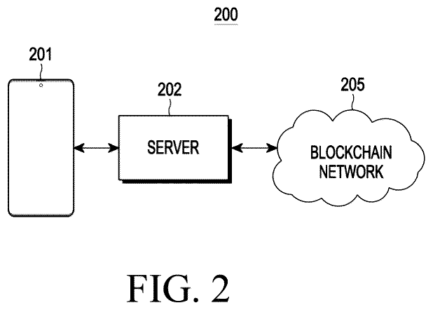

FIG. 2 is a block diagram illustrating a system including an electronic device, a server, and a blockchain network, according to an embodiment.

Referring to FIG. 2, according to an embodiment, a system 200 may include an electronic device 201, a server 202, and a blockchain network 205. For example, the system 200 may be an electronic system for the electronic device 201 to issue, manage, and/or trade non-fungible tokens (NFTs) for works in the blockchain network 205 through the server 202.

According to an embodiment, the electronic device 201 may issue, manage, and/or trade NFTs for works at a designated blockchain address (e.g., the first blockchain address) through the blockchain network 205. For example, the electronic device 201 may be implemented identically or similarly to the electronic device 101, 102, or 104 of FIG. 1. For example, a blockchain address may refer to an identifier that is established for a user designated in the blockchain network 205 and may access transaction information stored in nodes of the blockchain network 205. For example, an address of an NFT issued by the electronic device 201 may correspond to a blockchain address (or at least a portion of a public key) designated to the electronic device 201 (or a first wallet application installed in the electronic device 201). Alternatively, an address of an NFT issued by the server 202 may correspond to a blockchain address (or at least a portion of a public key) designated to the server 202 (or a wallet application related to the server 202).

According to an embodiment, the server 202 may issue, manage, and/or trade NFTs for works at a designated blockchain address (e.g., the blockchain address designated to the server 202) through the blockchain network 205. For example, an address of an NFT issued by the server 202 may correspond to a blockchain address designated to the server 202 (or a second wallet application installed in the server 202). For example, the server 202 may be implemented identically or similarly to the server 108 of FIG. 1.

According to an embodiment, a blockchain address (or account) may correspond to a public key generated from a root seed through several steps, or may be generated from the public key, among a public key/private key (or secret key) pair. If a new transaction occurs, the electronic device 201 may digitally sign transaction data using a private key (or secret key) paired with a public key associated with the corresponding address (or account) and transmit it to the blockchain network 205.

According to an embodiment, a blockchain wallet application may access a user's NFTs and perform operations such as key and address management, identifying metadata of works for NFTs, and creating and signing transactions for trading. According to an embodiment of the disclosure, a user's NFTs may be recorded on the blockchain network 205 by nodes participating through the blockchain network 205. The blockchain wallet application may include a private key and public keys for generating transactions to be included (or recorded) in the blockchain network 205. A user may send and receive the user's NFTs through signing transactions with the user's private key through a blockchain wallet application. For example, a node participating through the blockchain network 205 may be an electronic device included in the blockchain network 205 that performs a role of transmitting transactions in the blockchain network 205, and may be the same or at least partially similar to the electronic devices 101, 102, 104 of FIG. 1. However, nodes participating through the blockchain network 205 are not limited to this and may be implemented as some computers or system components (e.g., the processor, memory). Further, the blockchain network 205 may use mobile edge computing technology of 5G communication technology, and nodes of the blockchain network 290 may be implemented as mobile edge computing servers. For example, creating or generating a transaction may mean digitally signing transaction data using a private key.

According to an embodiment, issuing an NFT may mean recording transaction data including an address designated to a blockchain wallet application and information related to works related to the NFT (e.g., work information, address of a smart contract for issuing the NFT, conditions of the smart contract, code of the smart contract) on nodes of the blockchain network 205 by digitally signing with a private key related to the address. For example, the operation of issuing an NFT may mean a series of operations of distributing and recording information (e.g., metadata) about works to nodes participating through (or included in) the blockchain network 205, and as a result, generating a token (e.g., NFT) including information about a token ID and a blockchain address that executed the smart contract. After an NFT is issued, metadata of the NFT may be viewed through the corresponding blockchain address.

According to an embodiment, changing or transferring ownership of an NFT may mean an operation of transferring ownership of the NFT to a blockchain address (e.g., an address designated to a blockchain wallet application) that is the target of change or transfer. For example, the operation of changing or transferring ownership of an NFT may mean a series of operations of distributing and recording information (e.g., metadata) about works to nodes participating through (or included in) the blockchain network 205, and as a result, recording information about a token ID and a blockchain address that executed the smart contract in a pre-created token (e.g., NFT). After ownership of an NFT is changed (or transferred), metadata of the NFT with information about the changed blockchain address recorded may be viewed through the changed blockchain address.

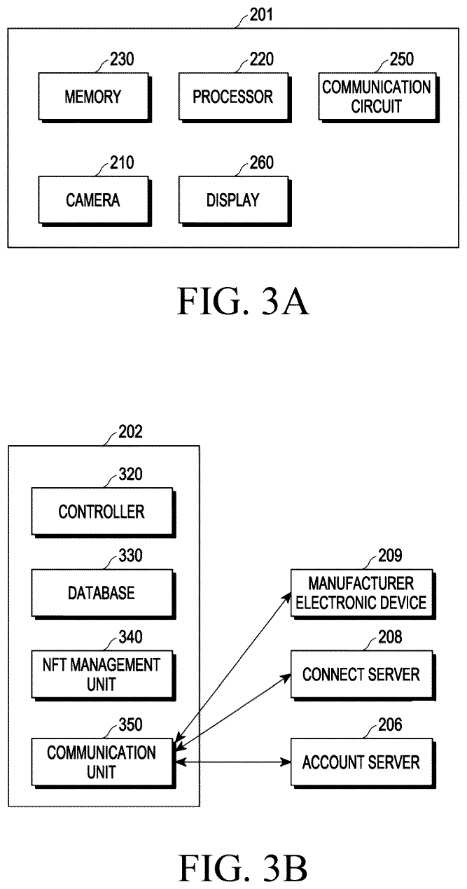

FIG. 3A is a block diagram illustrating a schematic configuration of an electronic device according to an embodiment.

Referring to FIG. 3A, according to an embodiment, an electronic device 201 may include a processor 220, a camera 210, memory 230, a communication circuit 250, and a display 260.

According to an embodiment, the processor 220 may control the overall operation of the electronic device 201.

According to an embodiment, the processor 220 may execute a blockchain wallet application (hereinafter, the first wallet application) stored in the memory 230 (e.g., the memory 130 of FIG. 1). At least some of the operations in which the processor 220 controls the electronic device 201 described below may be performed by the first wallet application.

According to an embodiment, the processor 220 may request the blockchain network to change or transfer ownership of a non-fungible token (NFT) through the first wallet application so that ownership of an NFT for an external electronic device is changed in the blockchain network (e.g., the blockchain network of FIG. 2). The processor 220 may request the blockchain network 205 to change or transfer ownership of an NFT to a first blockchain address designated to a first wallet application stored or installed in the electronic device 201. For example, the first wallet application may be a blockchain wallet application stored or installed in the electronic device 201. The first wallet application may perform a function of a blockchain cold wallet. The first blockchain address may be a blockchain address of the blockchain network 205 to which the first wallet application is designated.

According to an embodiment, the blockchain network 205 may request the electronic device 201 to approve a signature for changing ownership of an NFT. For example, the blockchain network 205 may request a signature (e.g., digital signature) or approval of a signature (e.g., digital signature) for changing ownership of an NFT to a blockchain address that requested the change of ownership of the NFT. For example, the blockchain network 205 may request approval of a signature to an address corresponding to a public key that requested the change of ownership of the NFT among public keys pre-recorded in nodes. If the electronic device 201 requested the change of ownership of the NFT, the blockchain network 205 may request the electronic device 201 to approve a first signature.

According to an embodiment, if approval of a first signature for changing ownership of an NFT is requested from the blockchain network 205, the processor 220 may display information for approving the first signature on the display 260 (e.g., the display module 160 of FIG. 1). The processor 220 may digitally sign (hereinafter, the first signature) transaction data using a first private key (or first secret key) paired with a first public key associated with the first address through the first wallet application. Thereafter, the processor 220 may transmit information about approval of the first signature to the blockchain network 205.

According to an embodiment, the processor 220 may determine whether to approve the first signature based on a user input for information for approving the first signature. For example, if it is identified that the first signature is approved, the processor 220 may provide information indicating approval of the first signature to the blockchain network. Ownership of the NFT may be changed by the blockchain network 205 based on the first signature (or approval of the first signature).

According to an embodiment, if ownership of the corresponding NFT is changed, the processor 220 may receive a message from the server 202 indicating that ownership of the NFT has been changed. The processor 220 may display information about the message on the display 260.

According to an embodiment, the processor 220 may obtain identification information (e.g., unique device identifier (UDID)) of an external electronic device (hereinafter, the first identification information) and identification information (e.g., NFT ID) of an NFT corresponding to the external electronic device (hereinafter, the second identification information) through the camera 210. For example, the processor 220 may capture (or scan) a QR code indicating identification information of an external electronic device through the camera 210. The processor 220 may obtain identification information of the external electronic device and identification information of the NFT based on the captured QR code. For example, a QR code may include a plurality of dots (or codes implemented as dots). The plurality of dots may indicate identification information of an external electronic device and identification information of an NFT corresponding to the external electronic device. Further, the plurality of dots may further include information for obtaining ownership of a non-fungible token (NFT) for an external electronic device (e.g., a command to execute a first wallet application stored in the memory 230). For example, an external electronic device may mean an electronic device that provides specific functions (e.g., cleaning function, refrigeration function, air conditioning function, air purification function, TV function, laptop function, or smartphone function) based on account information of a user registered in the server 202 or an account server (e.g., the account server 206 of FIG. 3B). For example, the external electronic device 202 may include internet of things (IoT) devices or computing devices (e.g., laptop, PC, smartphone, or wearable electronic device) supporting wireless communication functions.

According to an embodiment, the processor 220 may access the blockchain network 205 through the communication circuit 250 to obtain an NFT for an external electronic device based on obtaining the first identification information of the external electronic device and the second identification information of the NFT of the external electronic device. For example, the processor 220 may access the blockchain network 205 using a first wallet application stored in memory.

According to an embodiment, the processor 220 may request the server 202 to change ownership of an NFT for an external electronic device issued to the blockchain network 205 by transmitting a first blockchain address of a first wallet application stored in the memory 230, first account information registered in an account server 206, the first identification information, and the second identification information to the server 202. If the first blockchain address and the first account information are recorded or updated in the corresponding NFT in the blockchain network 205, ownership of the NFT may be changed to the first blockchain address. For example, the first account information may indicate account information of a first user who purchased (e.g., initially purchased) an external electronic device. For example, the first account information may be pre-registered in the account server 206 or may be created and registered when requesting a change of ownership of an NFT. For example, other account information not registered in the account server 206 (e.g., ENS information) may be used as the first account information.

According to an embodiment, initial ownership of an NFT for an external electronic device may be designated to a blockchain address related to a manufacturer of the external electronic device. A first user who purchased (e.g., initially purchased) an external electronic device may obtain ownership of an NFT through the electronic device 201. For example, as the server 202 transmits the first blockchain address and the first account information to the blockchain network 205, ownership of an NFT for an external electronic device may be changed from a blockchain address related to a manufacturer to a first blockchain address of a first wallet application. A first user who purchased an external electronic device may also obtain ownership of an NFT through the electronic device 201.

According to an embodiment, after ownership of an NFT for an external electronic device is changed to the first blockchain address, transfer of ownership of the NFT may be requested. A second user who purchased (e.g., purchased used) an external electronic device from a first user may receive transfer of ownership of an NFT for the external electronic device. According to an embodiment, if transfer of ownership of an NFT for an external electronic device is requested after ownership of the NFT is changed to the first blockchain address, the processor 220 may transmit at least one of a second blockchain address of a second wallet application stored in a second electronic device (e.g., a terminal of a second user) or second account information registered in the account server 206 (e.g., account information of a second user) to the server 202. For example, if the second blockchain address and the second account information are recorded or updated in an NFT for an external electronic device in the blockchain network 205 through the server 202, ownership of the NFT for the external electronic device may be changed or transferred from the first blockchain address to the second blockchain address.

According to an embodiment, the processor 220 may receive input of at least one of the second blockchain address or the second account information on an execution screen of the first wallet application. When the second blockchain address and the second account information are linked (or mapped) in the blockchain network 205, the processor 220 may transmit either the second blockchain address or the second account information to the server 202 for transfer of ownership of an NFT for an external electronic device. However, when the second blockchain address and the second account information are not linked (or mapped) in the blockchain network 205, the processor 220 may transmit the second blockchain address and the second account information to the server 202 for transfer of ownership of an NFT for an external electronic device.

According to an embodiment, the processor 220 may display information about NFTs issued in the blockchain network 205 through the display 260. For example, the processor 220 may display information about at least one of information about works (e.g., external electronic device) for NFTs, issuance time, transaction history, transaction time, or number of transactions.

According to an embodiment, based on executing the first wallet application, information about at least one NFT corresponding to the first blockchain address may be displayed on the display 260. For example, if the first blockchain address and the first account information are recorded or updated in an NFT for an external electronic device in the blockchain network 205, information about the corresponding NFT may be displayed on an execution screen of the first wallet application. For example, information indicating that ownership of an NFT for an external electronic device is designated to the first blockchain address may be displayed on an execution screen of the first wallet application.

According to an embodiment, the processor 220 may store information related to blockchain functions in the memory 230. The processor 220 may store at least part of the information related to the blockchain function in a secure area of the memory 230. For example, information related to a blockchain address (e.g., the first blockchain address) (e.g., root seed) may be stored in the secure area of the memory 230.

According to an embodiment, the processor 220 may also store information related to a blockchain address (e.g., the first blockchain address) (e.g., root seed) in memory external to the electronic device 201 (or an external electronic device). For example, the secure area may be a partial area of memory (e.g., the memory 130 of FIG. 1) that is divided into physical and/or logical areas and configured to allow access only to authorized processes. For example, the secure area may include a TrustZone.

FIG. 3B is a block diagram illustrating a schematic configuration of a server according to an embodiment.

Referring to FIG. 3B, according to an embodiment, a server 202 may include a controller 320, a database 330, an NFT management unit 340, and a communication unit 350.

According to an embodiment, the controller 320 may control the overall operation of the server 202. The controller 320 may execute a blockchain third wallet application stored in the database 330 (e.g., the memory 130 of FIG. 1). At least some of the operations in which the controller 320 controls the server 202 described below may be performed by the third wallet application.

According to an embodiment, the database 330 may store content representing external electronic devices produced or sold by a manufacturer, metadata of NFTs corresponding to the external electronic devices, first identification information of external electronic devices (e.g., UDID), and second identification information of NFTs issued to the blockchain network 205 (e.g., NFT ID or token ID). According to the implementation, the database 330 may also store user information including account information and blockchain addresses of users.

According to an embodiment, if a request to change ownership of an NFT corresponding to an external electronic device is identified from the electronic device 201, the controller 320 may perform a series of operations for changing ownership of the corresponding NFT. For example, the controller 320 may identify (or verify) whether identification information received from the electronic device 201 (e.g., the first identification information and the second identification information) matches identification information stored in the database 330.

According to an embodiment, based on a result of the check, the controller 320 may request the blockchain network 205 to change ownership of the corresponding NFT through the communication unit 350.

According to an embodiment, the controller 320 may perform functions related to issuing, managing, and trading NFTs. For example, the controller 320 may perform at least one function of issuing, managing, and trading NFTs through the NFT management unit 340. For example, at least a portion of the NFT management unit 340 may be implemented in hardware or software. If at least a portion of the NFT management unit 340 is implemented in software, the corresponding software may be executed by the controller 320.

According to an embodiment, the controller 320 may request the blockchain network 205 to issue an NFT for an external electronic device through the communication circuit 250. For example, initial ownership of an NFT for an external electronic device may be designated to a blockchain address of a wallet application stored in an electronic device of a manufacturer.

According to an embodiment, if an external electronic device is produced, the controller 320 may obtain information about the external electronic device through the communication circuit 250. For example, the information about the external electronic device may include content about the external electronic device (e.g., image, audio, video), link information to the content, product name, model name, production date, and/or information about production location. Further, the information about the external electronic device may include identification information of the external electronic device (e.g., UDID). Further, the information about the external electronic device may include metadata of an NFT corresponding to the external electronic device.

According to an embodiment, the controller 320 may transmit or upload information about the external electronic device to the blockchain network 205. The controller 320 may execute a smart contract (or smart contract code) in the blockchain network 205. The controller 320 may request issuance of an NFT for an external electronic device by distributing metadata of the NFT for the external electronic device to the blockchain network 205 through the executed smart contract. If an NFT for an external electronic device is issued in the blockchain network 205, information recorded in metadata of the corresponding NFT may be viewed. For example, an NFT (or metadata of an NFT) may include a third blockchain address and information about the external electronic device. Thereafter, the controller 320 may identify whether an NFT of an external electronic device has been issued through the communication unit 350.

According to an embodiment, the server 202 may transaction a blockchain address of the corresponding NFT to a blockchain address of a purchaser through the blockchain network 205 so that ownership of an NFT for an external electronic device belongs to a user who purchased the external electronic device. For example, a smart contract may include content to transaction a blockchain address of the corresponding NFT to a blockchain address of a purchaser so that ownership of an NFT for an external electronic device belongs to a user who purchased the external electronic device.

According to an embodiment, the controller 320 may access the blockchain network 205 through the communication circuit 250 to monitor whether ownership of an NFT for an external electronic device has changed. For example, the controller 320 may periodically monitor whether ownership of an NFT for an external electronic device has changed.

According to an embodiment, if a change in ownership of an NFT for an external electronic device is identified, the controller 320 may update user information related to the corresponding NFT. For example, the controller 320 may add or update identification information of an external electronic device to user information corresponding to a new owner of an NFT (e.g., user information including a blockchain address updated in an NFT) stored in the account server 206 and/or the database 330. Further, the controller 320 may transmit account information corresponding to a blockchain address updated in an NFT to an external electronic device. As account information of a new user is transmitted to an external electronic device, the external electronic device may perform supported functions based on the account information without a separate process (e.g., a process requiring input of account information of a new user to the external electronic device).

According to an embodiment, if ownership of an NFT is changed to a blockchain address of a new user, the controller 320 may exclude identification information of an external electronic device from user information of an existing owner stored in the account server 206 and/or the database 330.

According to an embodiment, the controller 320 may identify a status of an external electronic device through the communication unit 350. If an external electronic device (or status of an external electronic device) is not identified for a designated period, the controller 320 may request the blockchain network 205 to burn an NFT for the external electronic device. For example, the controller 320 may burn the corresponding NFT in the blockchain network 205 by transmitting an NFT to the blockchain network through a wallet application without a private key (or with an unknown private key).

According to an embodiment, a smart contract may be a digital contract in which conditions and results are encoded in computer code. For example, computer code of a smart contract may be implemented to automatically execute in the blockchain network 205 and, if agreed conditions (e.g., providing metadata for an NFT or requesting issuance of an NFT) are met, a result (e.g., issuance of an NFT) is realized. Further, computer code of a smart contract may be implemented to automatically execute in the blockchain network 205 and, if agreed conditions (e.g., requesting change of ownership of an NFT) are met, a result (e.g., change of ownership of an NFT) is realized.

According to an embodiment, the controller 320 may transmit a message indicating a status of ownership of an NFT to the electronic device 201 through the communication unit 350. For example, if ownership of an NFT is changed, the controller 320 may transmit a message indicating the change of ownership of the NFT to the electronic device 201.

According to an embodiment, the controller 320 may transmit/receive data with the account server 206, a connect server 208, or a manufacturer electronic device 209 using the communication unit 350.

According to an embodiment, the controller 320 may refer to account information registered in the account server 206 to verify account information received from the electronic device 201. For example, the controller 320 may obtain account information registered in the account server 206 and perform a verification operation by comparing the obtained account information with account information received from the electronic device 201. Further, when account information needs to be changed, the controller 320 may transmit changed information (e.g., information about change of ownership of an NFT) to the account server 206.

According to an embodiment, the account server 206 may perform a function of managing accounts (or account information) provided by a manufacturer that manufactures or sells electronic devices (e.g., internet of things devices and/or computing devices). Further, the account server 206 may store account information including user information. For example, an account may mean an account of a user who uses or plans to use electronic devices manufactured by a manufacturer. For example, account information may include information about electronic devices from a manufacturer that a user has purchased or owns (e.g., identification information of the corresponding electronic device and/or identification information of an NFT of the corresponding electronic device).

According to an embodiment, the connect server 208 may perform a function of supporting electronic devices so that electronic devices manufactured or sold by a manufacturer may interwork (or communicate) with each other (e.g., a function of relaying data transmission/reception between electronic devices). For example, the connect server 208 may perform a function of supporting electronic devices so that multiple electronic devices may interwork with each other based on accounts registered in an account server. For example, the connect server 208 may relay data transmission/reception between multiple electronic devices registered to any one account.

According to an embodiment, the account server 206 may store and manage by linking (or mapping) account information of a user with a blockchain address of a wallet application stored in the user's electronic device. Further, the account server 206 may include or add identification information of an NFT designated to the corresponding blockchain address and/or identification information of an external electronic device to user information. For example, an NFT may be an NFT for an external electronic device.

According to an embodiment, the manufacturer electronic device 209 may include electronic devices managed by a manufacturer that manufactures or sells electronic devices (e.g., internet of things devices and/or computing devices). For example, the electronic device 209 of the manufacturer may store a wallet application for creating and managing NFTs of electronic devices produced, sold, or managed by a manufacturer. The manufacturer electronic device 209 may request issuance of an NFT corresponding to a manufacturer's electronic device to a blockchain network (e.g., the blockchain network 205 of FIG. 2) using a wallet application. The manufacturer electronic device 209 may distribute smart contract code for issuing and changing ownership of the corresponding NFT to the blockchain network 205. Thereafter, if the corresponding NFT is issued to the blockchain network 205, the electronic device 209 of the manufacturer may transmit identification information of the NFT (e.g., NFT ID) to the server 202.

Meanwhile, in FIG. 3B, the server 202, the account server 206, the connect server 208, and the electronic device 209 of the manufacturer are illustrated as separate components, but the technical spirit of the disclosure may not be limited thereto. According to the implementation, the corresponding components may be implemented as a single server. Alternatively, the corresponding components may be implemented as multiple servers different from FIG. 3B. Meanwhile, the following flowcharts describe the subjects of operations as the electronic device 201 and the server 202 for convenience of description, but at least some of the operations performed by the electronic device 201 may be performed by the processor 220. Similarly, at least some of the operations performed by the server 202 may be performed by the controller 320.

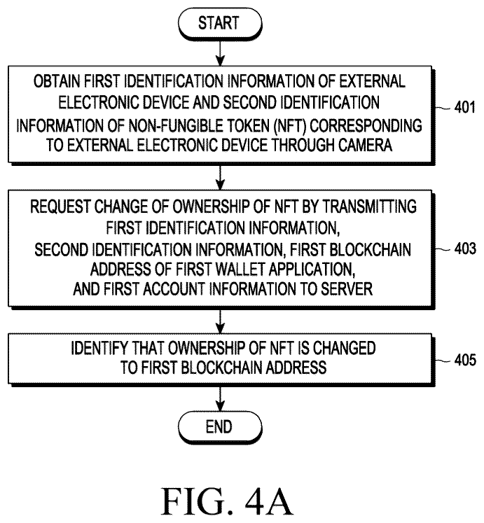

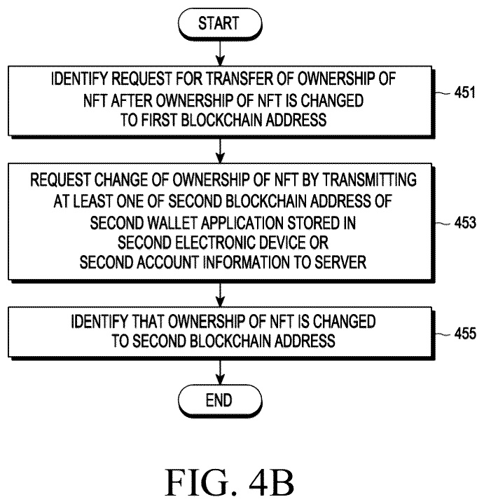

FIG. 4A is a flowchart illustrating a method for an electronic device to obtain ownership of an NFT for an external electronic device, according to an embodiment.

Referring to FIG. 4A, according to an embodiment, in operation 401, an electronic device (e.g., the electronic device 201 of FIG. 2) may obtain first identification information (e.g., UDID) of an external electronic device (e.g., an internet of things device) and second identification information (e.g., NFT ID) of a non-fungible token (hereinafter, NFT) for the external electronic device through a camera (e.g., the camera 310 of FIG. 3A). For example, the electronic device 201 may capture a QR code attached to an external electronic device through the camera 310 and obtain the first identification information of the external electronic device and the second identification information of the NFT from the captured QR code. Further, the electronic device 201 may execute a first wallet application stored in the electronic device 201 (e.g., the memory 230 of FIG. 3A) based on capturing the QR code. For example, a QR code attached to an external electronic device may include dots (or codes) indicating a command to execute a first wallet application, the first identification information, and the second identification information. For example, a QR code attached to an external electronic device may include a command for the server 202 to perform a series of operations to obtain a non-fungible token (NFT) for the external electronic device. According to the implementation, a QR code attached to an external electronic device may also include a command to create a new blockchain address of a first wallet application in the blockchain network 205 to obtain a non-fungible token (NFT) for the external electronic device.

According to the implementation, the electronic device 201 may also receive input of a first identification number of an external electronic device and second identification information of an NFT for the external electronic device based on user input.

According to an embodiment, in operation 403, in response to obtaining the first identification information of the external electronic device and the second identification information of the NFT for the external electronic device, the electronic device 201 may request the server 202 to change ownership of the NFT by transmitting the first identification information, the second identification information, a first blockchain address of the first wallet application, and first account information of a user (e.g., a user of the electronic device 201) stored in the electronic device 201 to the server 202.

According to an embodiment, the server 202 may perform a series of operations to change ownership of an NFT for an external electronic device in the blockchain network 205 using the first identification information, the second identification information, the first blockchain address of the first wallet application, and the first account information. For example, the server 202 may execute a smart contract (or smart contract code) distributed to nodes participating in (or included in) the blockchain network 205. The server 202 may request the blockchain network 205 to change ownership of an NFT from a manufacturer to the first blockchain address using the executed smart contract. For example, a smart contract (or smart contract code) may be configured to execute functions for changing ownership of an NFT.

According to an embodiment, in operation 405, if ownership of an NFT (or metadata of an NFT) for an external electronic device is recorded or updated to the first blockchain address (and/or the first account information) in the blockchain network 205, the electronic device 201 may identify that ownership of the NFT for the external electronic device is changed to the first blockchain address.

FIG. 4B is a flowchart illustrating a method for an electronic device to change ownership of an NFT for an external electronic device, according to an embodiment.

Referring to FIG. 4B, according to an embodiment, in operation 451, the electronic device 201 may identify whether transfer of ownership of an NFT is requested after ownership of an NFT for an external electronic device is changed to the first blockchain address. For example, if user input for an object requesting transfer of ownership of an NFT for an external electronic device is identified on an execution screen of the first wallet application, the electronic device 201 may identify that transfer of ownership of the corresponding NFT is requested.

According to an embodiment, if it is identified that transfer of ownership of an NFT for an external electronic device is requested, in operation 453, the electronic device 201 may request change or transfer of ownership of the NFT of the external electronic device by transmitting at least one of a second blockchain address of a second wallet application stored in a second electronic device or second account information of a user of the second electronic device to the server 202. For example, the electronic device 201 may request change or transfer of ownership of the corresponding NFT by transmitting at least one of a second blockchain address of a second wallet application stored in a second electronic device of a new user (e.g., a new purchaser of an external electronic device) or second account information of the new user registered in the account server 206 to the server 202. For example, to request transfer of ownership of an NFT for an external electronic device, the electronic device 201 may receive input of at least one of the second blockchain address or the second account information on an execution screen of the first wallet application. For example, if the second blockchain address (and/or the second account information) is recorded or updated in an NFT (or metadata of an NFT) for an external electronic device in the blockchain network 205, ownership of the NFT for the external electronic device may be changed to the second blockchain address.

According to an embodiment, the server 202 may perform a series of operations to change ownership of an NFT for an external electronic device in the blockchain network 205 using the first identification information of the external electronic device, the second identification information of the corresponding NFT, the second blockchain address of the second wallet application, or the second account information. For example, the server 202 may execute a smart contract distributed to the blockchain network 205. The server 202 may request the blockchain network 205 to change ownership of an NFT from the first blockchain address to the second blockchain address using the executed smart contract.

In operation 455, if ownership of an NFT (or metadata of an NFT) for an external electronic device is recorded or updated to the second blockchain address (and/or the first account information) in the blockchain network 205, the electronic device 201 may identify that ownership of the NFT for the external electronic device is changed to the second blockchain address. Further, the second electronic device may also identify that ownership of the NFT for the external electronic device is changed to the second blockchain address using the second wallet application.

Through the method described above, if ownership of an external electronic device is transferred, the electronic device 201 may also transfer ownership of an NFT for the external electronic device. Accordingly, a user purchasing an external electronic device may effectively prove ownership of the external electronic device using an NFT. Further, a user purchasing an external electronic device may accurately and effectively identify information about the external electronic device (e.g., product name, model name, production date, and/or production location, transaction history, and repair records) by viewing or querying information recorded in an NFT (or metadata of an NFT). Further, by the electronic device 201 transferring ownership of an NFT, account information of a new user recorded in the corresponding NFT may also be linked and transferred with the external electronic device. Accordingly, a user purchasing an external electronic device may conveniently use functions based on account information supported by the external electronic device without additional operations.

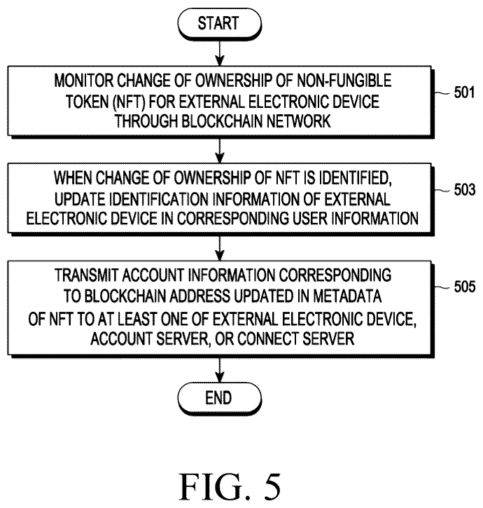

FIG. 5 is a flowchart illustrating a method of operating a server when a change in ownership of an NFT for an external electronic device is identified, according to an embodiment.

Referring to FIG. 5, according to an embodiment, in operation 501, a server (e.g., the server 202 of FIG. 2) may monitor changes in ownership of a non-fungible token (NFT) for an external electronic device through a blockchain network (e.g., the blockchain network 205 of FIG. 2). For example, the server 202 may periodically access the blockchain network 205 to identify for changes in ownership of an NFT for an external electronic device. For example, the server 202 may identify for changes in ownership of the corresponding NFT by identifying a blockchain address updated in metadata of an NFT for an external electronic device.

According to an embodiment, in operation 503, if a change in ownership of an NFT for an external electronic device is identified, the server 202 may update identification information (e.g., UDID) of the external electronic device in corresponding user information (e.g., user information of a changed NFT owner) stored in a database (e.g., the database 330 of FIG. 3B). Alternatively, if a change in ownership of an NFT for an external electronic device is identified, the server 202 may transmit a command to update corresponding user information (e.g., user information of a changed NFT owner) to an account server (e.g., the account server 206 of FIG. 3B).

According to an embodiment, in operation 505, the server 202 may transmit account information corresponding to (or mapping to) a blockchain address updated in metadata of an NFT for an external electronic device to at least one of the external electronic device, an account server (e.g., the account server 206 of FIG. 3B), or a connect server (e.g., the connect server 208 of FIG. 3B). The external electronic device may perform corresponding functions based on new account information. The account server 206 may add identification information (e.g., UDID) of the external electronic device to the second account information. The connect server 208 may also add identification information (e.g., UDID) of the external electronic device to the second account information.

Accordingly, a user purchasing an external electronic device may conveniently use functions based on account information supported by the external electronic device without additional operations.

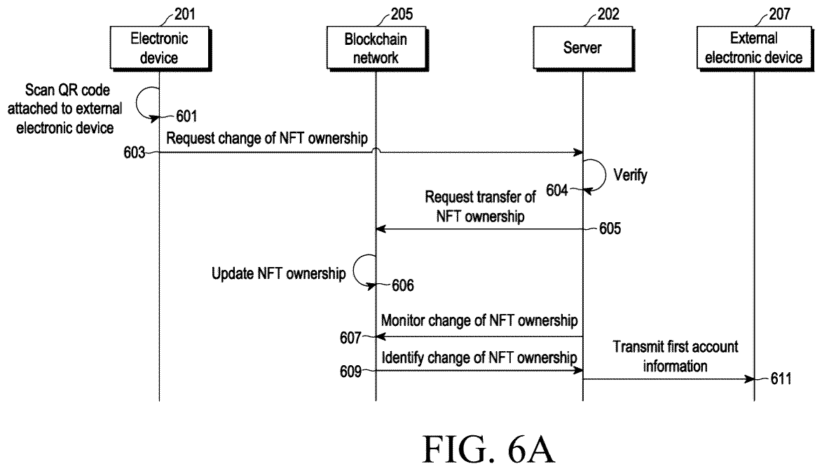

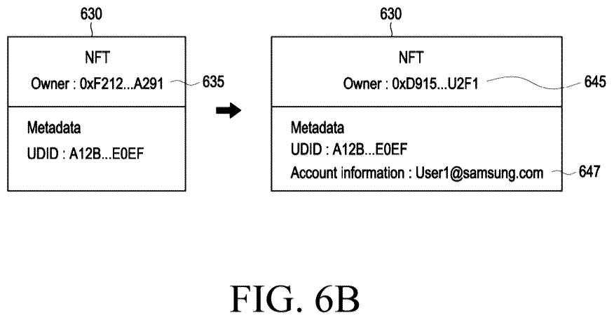

FIG. 6A is a flow diagram illustrating a method for an electronic device to obtain ownership of an NFT for an external electronic device purchased by a user of the electronic device, according to an embodiment. FIG. 6B is a view illustrating a method of obtaining ownership of an NFT, according to an embodiment.

Referring to FIG. 6A, according to an embodiment, in operation 601, the electronic device 201 may scan a QR code attached to an external electronic device 207 using a camera (e.g., the camera 310 of FIG. 3A). The electronic device 201 may obtain first identification information of the external electronic device and second identification information of an NFT for the external electronic device from the QR code. Alternatively, the electronic device 201 may obtain the first identification information of the external electronic device 207 and the second identification information of the NFT by directly receiving input. For example, the external electronic device 207 may mean an electronic device that performs functions based on account information of a user registered in the server 202. For example, the external electronic device 207 may be implemented as an internet of things (IoT) device.

According to an embodiment, in operation 603, the electronic device 201 may request the server 202 to change ownership of an NFT for the external electronic device 207 by transmitting the first identification information, the second identification information, the first blockchain address, and the first account information to the server 202.

According to an embodiment, in operation 604, the server 202 may perform a verification operation for changing ownership of an NFT. For example, as a verification operation, the server 202 may determine whether pre-stored first identification information and second identification information of the external electronic device 207 match the first identification information and second identification information received from the electronic device 201. If the server 202 determines that the corresponding information matches, it may identify that verification is complete. If it is identified that verification is complete, the server 202 may perform a series of operations to change ownership of an NFT.

According to an embodiment, if the server 202 determines that the corresponding information does not match, it may identify that verification is not complete. In this case, the server 202 may not perform a series of operations to change ownership of an NFT. Further, the server 202 may transmit a message notifying of the mismatch of the corresponding information to the electronic device 201.

According to an embodiment, in operation 605, the server 202 may request the blockchain network 205 to change ownership of an NFT for the external electronic device 207. For example, the server 202 may execute a smart contract distributed to the blockchain network 205 to request changing ownership of an NFT for the external electronic device 207. In this case, the server 202 may request change of ownership of an NFT by inputting the first blockchain address to the smart contract.

According to an embodiment, in operation 606, the blockchain network 205 may update ownership of an NFT for the external electronic device 207. Referring to FIG. 6B, first identification information (UDID) of an external electronic device and a blockchain address 635 of an existing owner (or initial owner (e.g., manufacturer)) (e.g., a blockchain address of a wallet application stored in an electronic device related to a manufacturer) may be recorded in metadata 630 of an NFT. The blockchain network 205 may update the metadata 630 of the NFT (e.g., update from an existing blockchain address to a new first blockchain address) based on a request to change ownership of the NFT. For example, as a result of the update, a first blockchain address 645 of a new owner (or first wallet application) may be recorded in the metadata 630 of the NFT. Further, first account information 647 may be added to the metadata 630 of the NFT. For example, the blockchain network 205 may map the first blockchain address 645 with the first account information 647.

According to an embodiment, ownership of the NFT of the external electronic device 207 may be designated to the first blockchain address 645. The blockchain network 205 may distribute the NFT of the external electronic device 207, in which the first blockchain address 645 and the first account information 647 are recorded, to nodes included in the blockchain network 205.

According to an embodiment, in operation 607, the server 202 may monitor whether ownership of the NFT for the external electronic device 207 has changed. For example, the server 202 may periodically access the blockchain network 205 to identify whether ownership of the NFT for the external electronic device 207 has changed.

According to an embodiment, in operation 609, the server 202 may identify a change in ownership of the NFT for the external electronic device 207. The server 202 may add identification information of the external electronic device 207 corresponding to the NFT to user information of a user of the electronic device 201 stored in a database (e.g., the database 330 of FIG. 3B).

According to an embodiment, in operation 611, the server 202 may transmit first account information corresponding to (or linked with) a blockchain address updated in metadata of the NFT of the external electronic device 207 to the external electronic device 207. The external electronic device 207 may perform designated functions based on the first account information. For example, the external electronic device 207 may perform functions linked with the electronic device 201 of a user registered in the first account information. Or, e.g., the external electronic device 207 may also perform functions linked with another electronic device of a user registered in the first account information.

According to an embodiment, the server 202 may transmit information indicating a change in ownership of an NFT (e.g., information indicating that ownership of an NFT is changed to the first blockchain address corresponding to the first account information) to an account server (e.g., the account server 206 of FIG. 3B) and/or a connect server (e.g., the connect server 208 of FIG. 3B). The account server 206 and the connect server 208 may add information about acquisition of ownership of an NFT and acquisition of ownership of the external electronic device 207 to the first account information.

Accordingly, a user purchasing an external electronic device may conveniently use functions based on account information supported by the external electronic device without separately adding account information.

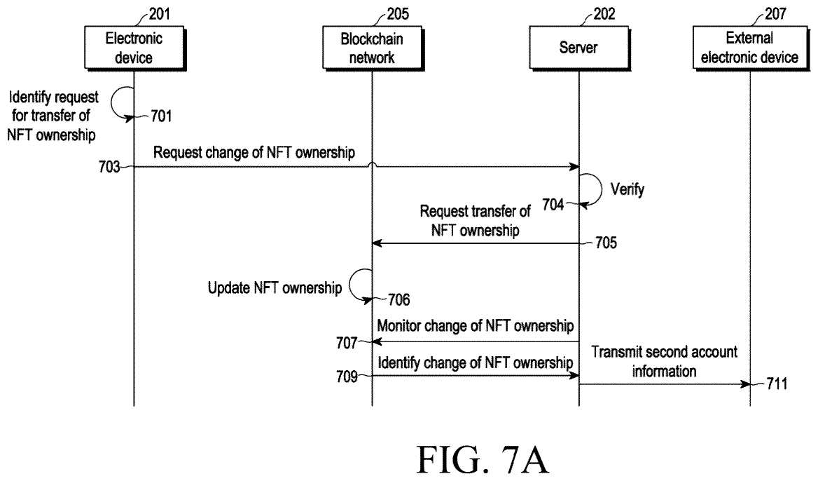

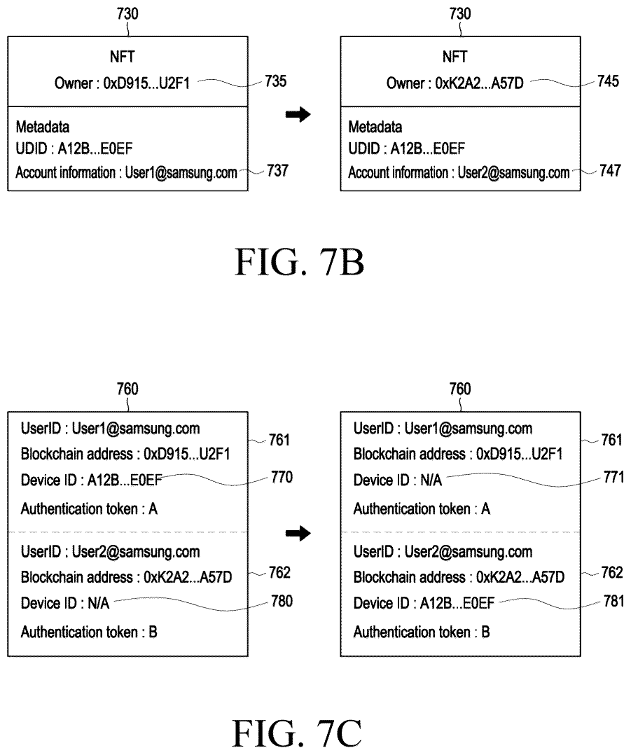

FIG. 7A is a flow diagram illustrating a method for an electronic device to transfer ownership of an NFT for an external electronic device sold by a user of the electronic device, according to an embodiment. FIG. 7B is a view illustrating a method of transferring ownership of an NFT, according to an embodiment. FIG. 7C is a view illustrating a method for a server to update user information according to transfer of ownership of an NFT, according to an embodiment.

Referring to FIG. 7A, according to an embodiment, in operation 701, the electronic device 201 may identify a request to transfer ownership of an NFT for the external electronic device 207 to another blockchain address. For example, ownership of an NFT for the external electronic device 207 may be designated to a first blockchain address of a first wallet application installed in the electronic device 201. For example, the electronic device 201 may identify a request to transfer ownership of an NFT based on user input for an object transferring ownership of the corresponding NFT included in an execution screen of the first wallet application.

According to an embodiment, in operation 703, the electronic device 201 may request the server 202 to change ownership of an NFT for the external electronic device 207 by transmitting a second blockchain address of a second electronic device and second account information of a user of the second electronic device to the server 202. For example, when the second account information is pre-registered in the server 202 or when the server 202 may identify the second account information through an account server (e.g., the account server 206 of FIG. 3B), the electronic device 201 may transmit the second blockchain address (in this case, the second blockchain address is stored linked with the second account information) or the second account information to the server 202. Further, the electronic device 201 may transmit first identification information (e.g., UDID) of the external electronic device 207 and second identification information (e.g., NFT ID) of an NFT for the external electronic device 207 to the server 202. For example, the second electronic device may mean a terminal of a second user who purchased (or received) an external electronic device from a first user of the electronic device 201. Further, the second account information may mean account information of the second user registered in the server 202. For example, the electronic device 201 may obtain the second blockchain address and/or the second account information by directly receiving input. Alternatively, the electronic device 201 may obtain the second blockchain address and/or the second account information through a message received from the second electronic device (e.g., a message including the second blockchain address and/or the second account information).

According to an embodiment, in operation 704, the server 202 may perform a verification operation for changing ownership of an NFT. For example, as a verification operation, the server 202 may determine whether pre-stored first identification information and second identification information of the external electronic device 207 match the first identification information and second identification information received from the electronic device 201. If the server 202 determines that the corresponding information matches, it may identify that verification is complete. If it is identified that verification is complete, the server 202 may perform a series of operations to change ownership of an NFT.

According to an embodiment, if the server 202 determines that the corresponding information does not match, it may identify that verification is not complete. In this case, the server 202 may not perform a series of operations to change ownership of an NFT. Further, the server 202 may transmit a message notifying of the mismatch of the corresponding information to the electronic device 201.

According to an embodiment, in operation 705, the server 202 may request the blockchain network 205 to change ownership of an NFT for the external electronic device 207. For example, the server 202 may execute a smart contract distributed to the blockchain network 205 to request changing ownership of an NFT for the external electronic device 207. In this case, the server 202 may request change of ownership of an NFT by inputting the second blockchain address to the smart contract.

According to an embodiment, in operation 706, the blockchain network 205 may update ownership of an NFT for the external electronic device 207. Referring to FIG. 7B, first identification information (UDID) of an external electronic device and a first blockchain address 735 of an existing owner (e.g., first user) (e.g., a blockchain address of a first wallet application stored in a first electronic device 201 related to the first user) may be recorded in metadata 730 of an NFT. Further, first account information 737 of the existing owner may be recorded in the metadata 730 of the NFT. The blockchain network 205 may update the metadata 730 of the NFT (e.g., update from the first blockchain address to a new second blockchain address) based on a request to change ownership of the NFT. For example, as a result of the update, a second blockchain address 745 of a new owner (e.g., second user) (or second wallet application) may be recorded in the metadata 730 of the NFT. Further, second account information 747 of the new owner may be recorded in the metadata 730 of the NFT. For example, the blockchain network 205 may map the second blockchain address 745 with the second account information 747.

According to an embodiment, ownership of the NFT of the external electronic device 207 may be designated to the second blockchain address 745. The blockchain network 205 may distribute the NFT of the external electronic device 207, in which the second blockchain address 745 and the second account information 747 are recorded, to nodes included in the blockchain network 205.

According to an embodiment, in operation 707, the server 202 may monitor whether ownership of the NFT for the external electronic device 207 has changed. For example, the server 202 may periodically access the blockchain network 205 to identify whether ownership of the NFT for the external electronic device 207 has changed.

According to an embodiment, in operation 709, the server 202 may identify a change in ownership of the NFT for the external electronic device 207. The server 202 may update user information 760 stored in a database (e.g., the database 330 of FIG. 3B).

Referring to FIG. 7C, according to an embodiment, user information 760 may include first user information 761 for a first user and second user information 762 for a second user. For example, the first user information 761 may include first account information, a first blockchain address, identification information of registered devices, and information about authentication tokens. For example, the second user information 762 may include second account information, a second blockchain address, identification information of registered devices, and information about authentication tokens.

Referring to FIG. 7C, according to an embodiment, before the server 202 identifies the change in ownership, identification information of registered devices included in the first user information 761 may include identification information 770 of the external electronic device 207. On the other hand, information of registered devices included in the second user information 762 may include information 780 indicating none. As a result of updating the user information 760, identification information of registered devices included in the first user information 761 may include information 771 indicating none. Further, as a result of updating the user information 760, identification information of registered devices included in the second user information 762 may include identification information 781 of the external electronic device 207.

According to an embodiment, in operation 711, the server 202 may transmit second account information corresponding to (or linked with) a blockchain address updated in metadata of the NFT of the external electronic device 207 to the external electronic device 207. The external electronic device 207 may perform designated functions based on the second account information. For example, the external electronic device 207 may perform functions linked with the electronic device 201 of a user registered in the second account information. Or, e.g., the external electronic device 207 may also perform functions linked with another electronic device of a user registered in the second account information.

According to an embodiment, the server 202 may transmit information indicating a change in ownership of an NFT (e.g., information indicating that ownership of an NFT is changed to the second blockchain address corresponding to the second account information) to an account server (e.g., the account server 206 of FIG. 3B) and/or a connect server (e.g., the connect information 208 of FIG. 3B). The account server 206 and the connect server 208 may add information about acquisition of ownership of an NFT and acquisition of ownership of the external electronic device 207 to the second account information. Further, the account server 206 and the connect server 208 may add information about loss of ownership of an NFT and loss of ownership of the external electronic device 207 to the first account information. Alternatively, the account server 206 and the connect server 208 may delete information about ownership of an NFT and ownership of the external electronic device 207 from the first account information. Accordingly, a user purchasing an external electronic device may conveniently use functions based on account information supported by the external electronic device without separately adding account information.

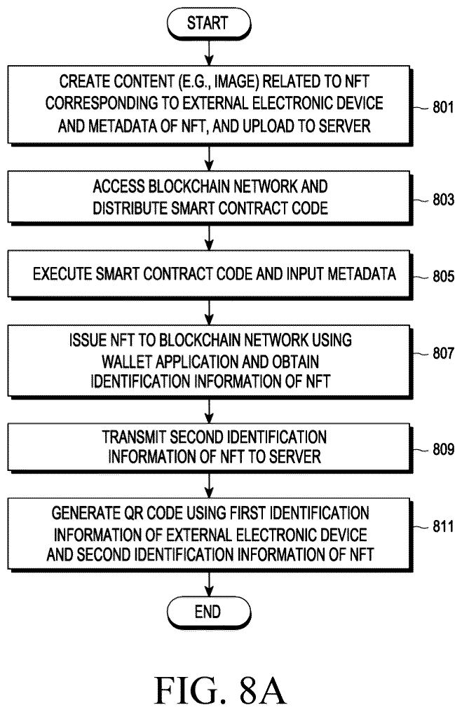

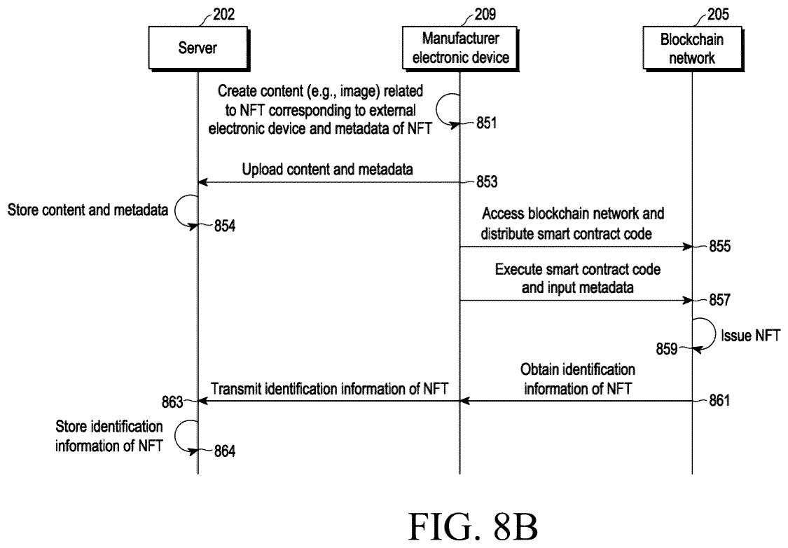

FIG. 8A is a flowchart illustrating a method of issuing an NFT for an external electronic device to a blockchain network, according to an embodiment.

Referring to FIG. 8A, according to an embodiment, in operation 801, if an external electronic device (e.g., the external electronic device 207 of FIGS. 6A and 7A) is produced, an electronic device of a manufacturer may create content representing the external electronic device 207 (e.g., image, audio, or video representing the external electronic device 207) and metadata to be included (or recorded) in the NFT (e.g., identification information of the external electronic device 207 (e.g., UDID), product name, model name, production date, information about production location, and/or link information to content representing the external electronic device 207). For example, the electronic device of a manufacturer may include electronic devices managed by a manufacturer that manufactures the external electronic device 207. For example, the electronic device of a manufacturer may store a wallet application for creating and managing NFTs of electronic devices produced or managed by the manufacturer.

According to an embodiment, the electronic device 201 of the manufacturer may store content representing the external electronic device 207 in a server (e.g., the server 202 of FIG. 3B). For example, link information to content included in metadata may include a link address (e.g., URL address) that may identify content stored in the server 202.

According to an embodiment, in operation 803, the electronic device of the manufacturer may access a blockchain network (e.g., the blockchain network 205 of FIGS. 6A and 7A) to distribute smart contract code for issuing and/or managing an NFT of the external electronic device 207.

According to an embodiment, in operation 805, the electronic device of the manufacturer may execute a smart contract (or smart contract code) to input metadata.

According to an embodiment, in operation 807, the electronic device of the manufacturer may request issuance of an NFT corresponding to the external electronic device 207 to the blockchain network 205 using a wallet application stored in the electronic device of the manufacturer. As an NFT corresponding to the external electronic device 207 is distributed (or recorded) to nodes included in the blockchain network 205, the NFT may be issued (or created) in the blockchain network 205. The electronic device of the manufacturer may obtain identification information of the NFT (e.g., second identification information or NFT ID) based on issuance of the NFT corresponding to the external electronic device 207.

According to an embodiment, in operation 809, the electronic device of the manufacturer may transmit identification information of the NFT (e.g., second identification information) to the server 202. The server 202 may obtain or receive identification information of an NFT corresponding to the external electronic device 207 from the electronic device of the manufacturer. Thereafter, the server 202 may perform a series of operations managing the NFT corresponding to the external electronic device 207 (e.g., changing ownership of the NFT and/or burning the NFT).

According to an embodiment, in operation 811, the electronic device of the manufacturer may create a QR code to attach to the external electronic device 207 using the first identification information of the external electronic device and the second identification information of the issued NFT. According to the implementation, operation 811 may be performed by an electronic device different from the electronic device of the manufacturer that requested issuance of the NFT.

FIG. 8B is a flow diagram illustrating a method of issuing an NFT for an external electronic device to a blockchain network, according to an embodiment.

Referring to FIG. 8B, according to an embodiment, in operation 851, a manufacturer electronic device 209 may create content related to an NFT corresponding to an external electronic device (e.g., the external electronic device 207 of FIGS. 6A and 7A) and metadata of the NFT. For example, content may include images, audio, and/or video representing the external electronic device 207. Metadata may represent information to be recorded in an NFT and may include identification information of the external electronic device 207 (e.g., UDID), product name, model name, production date, information about production location, and/or link information to content representing the external electronic device 207.

According to an embodiment, in operation 853, the electronic device 209 of the manufacturer may upload content and metadata to the server 202.

Meanwhile, operations 851 and 853 may be performed differently from what is illustrated in FIG. 8B. For example, the electronic device 209 of the manufacturer may create content and upload the created content to the server 202. Thereafter, the electronic device 209 of the manufacturer may create metadata and upload the created metadata to the server 202. However, this is an example, and the technical spirit of the disclosure is not limited thereto.

According to an embodiment, in operation 854, the server 202 may store content and metadata. For example, the server 202 may store content representing an external electronic device and identification information of the external electronic device (e.g., UDID) in a database (e.g., the database 330 of FIG. 3B).

According to an embodiment, in operation 855, the electronic device 209 of the manufacturer may access the blockchain network 205 to distribute smart contract code.

According to an embodiment, in operation 857, the electronic device 209 of the manufacturer may execute smart contract code to input metadata to a smart contract. In operation 859, based on metadata being input to the smart contract, an NFT corresponding to the external electronic device 207 may be issued to the blockchain network 205. For example, an issued NFT may be added (or recorded) to nodes included in the blockchain network 205.

According to an embodiment, in operation 861, the electronic device 209 of the manufacturer may obtain identification information of the NFT (e.g., NFT ID) based on the NFT being issued to the blockchain network 205.

According to an embodiment, in operation 863, the electronic device 209 of the manufacturer may transmit identification information of the NFT to the server 202. In operation 864, the server 202 may obtain the NFT corresponding to the external electronic device 207 and store it in the database 330. Thereafter, the server 202 may perform a series of operations related to managing the NFT corresponding to the external electronic device 207 (e.g., changing ownership of the NFT and/or burning the NFT). For example, when an electronic device of a new owner (e.g., purchaser) of the external electronic device 207 requests transfer of ownership of the NFT corresponding to the external electronic device 207, the server 202 may perform a series of operations for changing ownership of the NFT. Alternatively, when designated conditions are satisfied, the server 202 may perform a series of operations for burning the NFT.

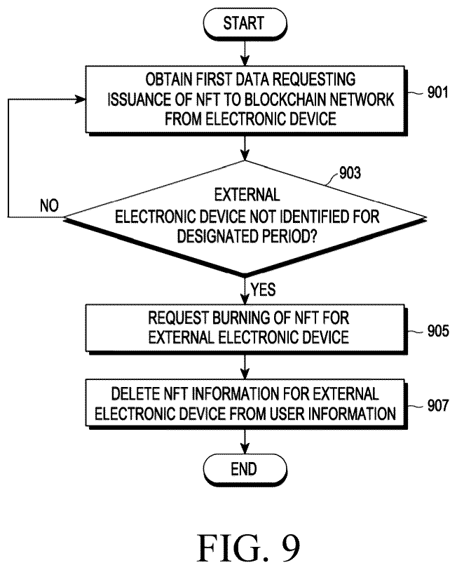

FIG. 9 is a flowchart illustrating a method for a server to burn an NFT for an external electronic device, according to an embodiment.

Referring to FIG. 9, according to an embodiment, in operation 901, a server (e.g., the server 202 of FIG. 2) may identify a status of an external electronic device (e.g., the external electronic device 207 of FIG. 6) for which an NFT has been issued. For example, if the external electronic device 207 is connected to a wired or wireless network (e.g., internet), the server 202 may identify the status of the external electronic device 207 through the wired or wireless network.

According to an embodiment, in operation 903, the server 202 may identify whether the external electronic device 207 has been unidentified for a designated period. For example, if the external electronic device 207 is not connected to a wired or wireless network for a designated period, the server 202 may not identify the external electronic device 207. For example, the server 202 may identify that the external electronic device 207 is unidentified if the external electronic device 207 is not connected to a wired or wireless network for a designated period.

According to an embodiment, if it is identified that the external electronic device 207 has not been unidentified for the designated period (No in operation 903), the server 202 may (continue to) manage the NFT for the external electronic device 207. For example, the server 202 may identify whether ownership of the NFT for the external electronic device 207 has changed.

According to an embodiment, if it is identified that the external electronic device 207 has been unidentified for the designated period (Yes in operation 903), in operation 905, the server 202 may request the blockchain network 205 to burn the NFT for the external electronic device 207.

According to an embodiment, in operation 907, the server 202 may delete information about the NFT for the external electronic device from user information stored in a database (e.g., the database 330 of FIG. 3B).

According to another embodiment, if it is identified that the external electronic device 207 has been unidentified for the designated period, prior to requesting the blockchain network 205 to burn the NFT for the external electronic device 207, the server 202 may transmit (or provide) a notification indicating that the external electronic device 207 is unidentified to a designated electronic device (e.g., the electronic device 201 of FIG. 2). For example, the notification may include information for identifying whether to burn the NFT for the external electronic device 207. For example, the designated electronic device (e.g., 201) may display information about the notification on a display. The pre-designated electronic device (e.g., 201) may transmit information indicating whether to burn the NFT for the external electronic device 207 to the server 202 based on user input for the information displayed on the display. For example, in response to user input corresponding to a request not to burn the corresponding NFT, the designated electronic device (e.g., 201) may transmit information requesting not to burn the corresponding NFT to the server 202. Alternatively, in response to user input corresponding to a request to burn the corresponding NFT, the designated electronic device (e.g., 201) may transmit information requesting to burn the corresponding NFT to the server 202. Thereafter, the server 202 may delete information about the NFT for the external electronic device from user information stored in a database (e.g., the database 330 of FIG. 3B).

Accordingly, the server 202 may efficiently manage NFTs by burning NFTs of external electronic devices that are unidentified for long periods.

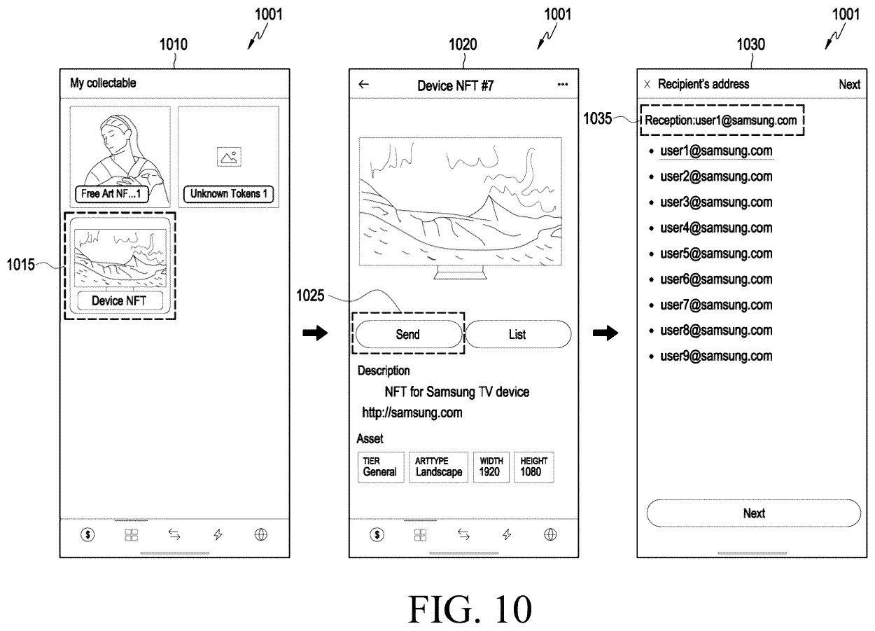

FIG. 10 is a view illustrating a method for an electronic device to transfer ownership of an NFT for an external electronic device through a user interface, according to an embodiment.

Referring to FIG. 10, an electronic device 1001 (e.g., the electronic device 201 of FIG. 2) may display execution screens 1010, 1020, 1030 of a first wallet application based on execution of the first wallet application.

According to an embodiment, the electronic device 1001 may display a first execution screen 1010 including information about at least one NFT designated to a first blockchain address of the first wallet application. The electronic device 1001 may display information about at least one NFT for which ownership was obtained through the first blockchain address through the first execution screen 1010. For example, information about at least one NFT may include images representing works or devices for the corresponding NFT.

According to an embodiment, the electronic device 1001 may select a first NFT 1015 requesting transfer (or change) of ownership among at least one NFT based on user input for the first execution screen 1010.

According to an embodiment, if the first NFT 1015 is selected, the electronic device 1001 may display a second execution screen 1020 for transferring (or changing) ownership of the first NFT 1015. The second execution screen 1020 may include an object 1025 for transferring (or changing) ownership of the first NFT 1015. The electronic device 1001 may transfer ownership of the first NFT 1015 to another blockchain address based on user input for the second object 1025.

According to an embodiment, the electronic device 1001 may display a third execution screen 1030 for transferring ownership of the first NFT 1015 to another blockchain address. For example, the electronic device 1001 may select a blockchain address for transferring ownership of the first NFT 1015. For example, when a blockchain address is mapped to account information, the electronic device 1001 may transfer ownership of the first NFT 1015 to a blockchain address corresponding to selected account information. The electronic device 1001 may identify a blockchain address to transfer based on user input selecting account information to transfer to among multiple account information. Alternatively, when a blockchain address is not mapped to account information, the electronic device 1001 may receive input of a blockchain address to transfer to and transfer ownership of the first NFT 1015 to the input blockchain address.

Accordingly, a user selling an external electronic device may sell the external electronic device together with the corresponding NFT. Accordingly, a user purchasing an external electronic device may conveniently use functions based on account information supported by the external electronic device without separately adding account information.

According to an embodiment, a first electronic device 201 may include a camera 210, memory 230, a communication circuit 250, and a processor 220. According to an embodiment, the memory may store instructions. According to an embodiment, the instructions may, when executed by the processor, cause the electronic device to obtain first identification information of an external electronic device 207 and second identification information of a non-fungible token (NFT) for the external electronic device. According to an embodiment, the instructions may, when executed by the processor, cause the electronic device to transmit, through the communication circuit, a first blockchain address of a first wallet application stored in the memory, first account information of a user of the first electronic device, the first identification information, and the second identification information to a server based on obtaining the first identification information and the second identification information, to request the server to change ownership of the NFT created in a blockchain network. According to an embodiment, if the first blockchain address and the first account information are stored in the NFT in the blockchain network, the ownership of the NFT may be changed to the first blockchain address.

According to an embodiment, the processor may be configured to transmit at least one of a second blockchain address of a second wallet application stored in a second electronic device or second account information registered in the server to the server if transfer of ownership of the NFT to another blockchain address is requested after the ownership of the NFT is changed to the first blockchain address. According to an embodiment, the processor may change the ownership of the NFT to the second blockchain address if the second blockchain address and the second account information are stored in the NFT in the blockchain network.

According to an embodiment, when the second blockchain address and the second account information are linked in the blockchain network, the processor may be configured to transmit either the second blockchain address or the second account information to the server to request transfer of the ownership of the NFT.

According to an embodiment, to request the server to transfer the ownership of the NFT, the processor may be configured to receive input of at least one of the second blockchain address or the second account information on an execution screen of the first wallet application.

According to an embodiment, initial ownership of the NFT may be designated to a blockchain address related to a manufacturer of the external electronic device.

According to an embodiment, based on the first blockchain address and the first account information being transmitted to the blockchain network by a server, ownership of the NFT may be changed from the blockchain address related to the server to the first blockchain address.

According to an embodiment, the processor may be configured to capture a QR code attached to the external electronic device through the camera. According to an embodiment, the processor may be configured to obtain the first identification information and the second identification information based on the captured QR code.

According to an embodiment, the processor may be configured to display information about at least one NFT corresponding to the first blockchain address on a display 260 of the electronic device based on executing the first wallet application.

According to an embodiment, a method of operating a first electronic device 201 may include obtaining first identification information of an external electronic device 207 and second identification information of a non-fungible token (NFT) for the external electronic device. According to an embodiment, the method of operating the first electronic device may include transmitting a first blockchain address of a first wallet application stored in the first electronic device, first account information of a user of the first electronic device, the first identification information, and the second identification information to a server based on obtaining the first identification information and the second identification information, to request the server to change ownership of the NFT created in a blockchain network. According to an embodiment, if the first blockchain address and the first account information are stored in the NFT in the blockchain network, the ownership of the NFT may be changed to the first blockchain address.

According to an embodiment, the method of operating the first electronic device may further include transmitting to the server at least one of a second blockchain address of a second wallet application stored in a second electronic device or second account information registered in the server if transfer of ownership of the NFT to another blockchain address is requested after the ownership of the NFT is changed to the first blockchain address. According to an embodiment, if the second blockchain address and the second account information are stored in the NFT in the blockchain network, the ownership of the NFT may be changed to the second blockchain address.

According to an embodiment, transmitting at least one of the second blockchain address or the second account information to the server may include transmitting either the second blockchain address or the second account information to the server to request transfer of the ownership of the NFT when the second blockchain address and the second account information are linked in the blockchain network.

According to an embodiment, the method of operating the first electronic device may further include receiving input of at least one of the second blockchain address or the second account information on an execution screen of the first wallet application to request the server to transfer the ownership of the NFT.

According to an embodiment, initial ownership of the NFT may be designated to a blockchain address related to a manufacturer of the external electronic device, and based on the first blockchain address and the first account information being transmitted to the blockchain network by the server, ownership of the NFT may be changed from the blockchain address related to the manufacturer to the first blockchain address.

According to an embodiment, obtaining the first identification information and the second identification information may include capturing a QR code attached to the external electronic device through the camera. According to an embodiment, obtaining the identification information may include obtaining the first identification information and the second identification information based on the captured QR code.

According to an embodiment, the method of operating the first electronic device may further include displaying information about at least one NFT corresponding to the first blockchain address on a display 260 of the electronic device based on executing the first wallet application.

According to an embodiment, a server 202 may include a database 330 storing user information including account information and blockchain addresses of users, a communication unit 350, and a controller 230. According to an embodiment, the controller may be configured to request the blockchain network to change ownership of an NFT for the external electronic device to the first blockchain address through the communication unit, based on receiving first identification information of an external electronic device, second identification information of an NFT for the external electronic device, a first blockchain address of the electronic device, and first account information of a user of the electronic device from an electronic device. According to an embodiment, the controller may be configured to monitor changes in ownership of a non-fungible token (NFT) for an external electronic device 207 through a blockchain network 205. According to an embodiment, the controller may be configured to transmit information about ownership of the NFT to the external electronic device if a change in ownership of the NFT is identified.

According to an embodiment, the controller may be configured to request the blockchain network to change ownership of an NFT for the external electronic device from the first blockchain address to the second blockchain address through the communication unit, based on receiving a second blockchain address of a second electronic device and second account information of a user of the second electronic device from the electronic device.

According to an embodiment, the controller may be configured to identify whether the first identification information and the second identification information match identification information stored in an account server. According to an embodiment, the controller may be configured to request the blockchain network to change ownership of the NFT for the external electronic device to the first blockchain address based on a result of the check.

According to an embodiment, the controller may be configured to identify a status of the external electronic device through the communication unit. According to an embodiment, the controller may be configured to request the blockchain network to burn the NFT if the external electronic device is not identified for a designated period.

According to an embodiment, a computer-readable non-transitory recording medium may store instructions that cause an electronic device to perform operations of obtaining first identification information of an external electronic device 207 and second identification information of a non-fungible token (NFT) for the external electronic device, and based on obtaining the first identification information and the second identification information, transmitting a first blockchain address of a first wallet application stored in the electronic device, first account information of a user of the first electronic device, the first identification information, and the second identification information to a server through a communication circuit included in the electronic device to request the server to change ownership of the NFT created in a blockchain network. If the first blockchain address and the first account information are stored in the NFT in the blockchain network, the ownership of the NFT may be changed to the first blockchain address.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a camera;
a communication circuit;
a processor; and
memory configured to store instructions, wherein the instructions, when executed by the processor individually or collectively, cause the electronic device to:
obtain first identification information associated with an external electronic device and second identification information of a non-fungible token (NFT) associated with the external electronic device; and
based on obtaining the first identification information and the second identification information, transmit, to a server through the communication circuit, a first blockchain address of a first wallet application stored in the memory, first account information of a user of the electronic device, the first identification information, and the second identification information, the transmission comprising a request to change an ownership of the NFT created in a blockchain network,
wherein when the first blockchain address and the first account information are comprised in the NFT in the blockchain network, the ownership of the NFT is changed to the first blockchain address.

2. The electronic device of claim 1, wherein the instructions, when executed by the processor individually or collectively, cause the electronic device to:
subsequent to changing the ownership of the NFT to the first blockchain address, based on a transfer of the ownership of the NFT to another blockchain address being requested, transmit, to the server, at least one of a second blockchain address of a second wallet application stored in a second electronic device or a second account information registered in the server, and
wherein when the second blockchain address and the second account information are comprised in the NFT in the blockchain network, the ownership of the NFT is changed to the second blockchain address.

3. The electronic device of claim 2, wherein the instructions, when executed by the processor collectively or individually, cause the electronic device to:
based on the second blockchain address and the second account information being linked in the blockchain network, transmit, to the server, one of the second blockchain address or the second account information, the transmission of the second blockchain address or the second account information comprising the request transfer of the ownership of the NFT.

4. The electronic device of claim 2, wherein the instructions, when executed by the processor individually or collectively, cause the electronic device to:
receive an input of at least one of the second blockchain address or the second account information via the first wallet application to request the server to transfer the ownership of the NFT.

5. The electronic device of claim 1, wherein initial ownership of the NFT is designated to a blockchain address associated with a manufacturer of the external electronic device.

6. The electronic device of claim 5, wherein based on the first blockchain address and the first account information being transmitted to the blockchain network by the server, the ownership of the NFT is changed from the blockchain address associated with the manufacturer to the first blockchain address.

7. The electronic device of claim 1, wherein the instructions, when executed by the processor individually or collectively, cause the electronic device to:
capture, through the camera, a QR code associated with the external electronic device; and
obtain the first identification information and the second identification information based on the QR code.

8. The electronic device of claim 1, wherein the instructions, when executed by the processor individually or collectively, cause the electronic device to:
display information about at least one NFT corresponding to the first blockchain address on a display of the electronic device based on executing an operation of the first wallet application.

9. A method for operating an electronic device, the method comprising:
obtaining first identification information associated with an external electronic device and second identification information of a non-fungible token (NFT) associated with the external electronic device; and
based on obtaining the first identification information and the second identification information, transmitting, to a server, a first blockchain address of a first wallet application stored in the electronic device, first account information of a user of the electronic device, the first identification information, and the second identification information, the transmission comprising a request to change an ownership of the NFT created in a blockchain network,
wherein based on the first blockchain address and the first account information being comprised in the NFT in the blockchain network, the ownership of the NFT is changed to the first blockchain address.

10. The method of claim 9, further comprising:
subsequent to changing the ownership of the NFT to the first blockchain address, based on a transfer of the ownership of the NFT to another blockchain address being requested, transmitting, to the server, at least one of a second blockchain address of a second wallet application stored in a second electronic device or second account information registered in the server,
wherein based on the second blockchain address and the second account information being comprised in the NFT in the blockchain network, the ownership of the NFT is changed to the second blockchain address.

11. The method of claim 10, wherein the transmitting the at least one of the second blockchain address or the second account information to the server comprises:
based on the second blockchain address and the second account information being linked in the blockchain network, transmitting, to the server, one of the second blockchain address or the second account information, the transmission of the second blockchain address or the second account information comprising the request transfer of the ownership of the NFT.

12. The method of claim 10, further comprising:
receiving an input of at least one of the second blockchain address or the second account information via the first wallet application to request the server to transfer the ownership of the NFT.

13. The method of claim 9, wherein initial ownership of the NFT is designated to a blockchain address associated with a manufacturer of the external electronic device, and
based on the first blockchain address and the first account information being transmitted to the blockchain network by the server, the ownership of the NFT is changed from the blockchain address associated with the manufacturer to the first blockchain address.

14. The method of claim 9, wherein the obtaining the first identification information and the second identification information comprises:
capturing, through a camera, a QR code associated with the external electronic device; and
obtaining the first identification information and the second identification information based on the QR code.

15. The method of claim 9, further comprising:
displaying information about at least one NFT corresponding to the first blockchain address on a display of the electronic device based on executing an operation of the first wallet application.
